(19) United States
(12) Patent Application Publication
(10) Pub. No.: US 2006/0101702 A1
(43) Pub. Date: May 18, 2006

(54) Bait-casting rod handle

(76) Inventor: Brian O. LaCoste, Shreveport, LA (US)

Correspondence Address: John M. Harrison, 2139 E. Bert Kouns, Shreveport, LA, 71105, US

(21) Appl. No.: 11/214,128

(22) Filed: Aug. 29, 2005

Related U.S. Application Data
(60) Provisional application No. 60/628,154, filed on Nov. 16, 2004.

(51) Int. Cl. A01K 97/10; A01K 87/00; A01K 87/08

(52) U.S. Cl. 43/21.2; 43/25

(57) ABSTRACT

A handle for bait-casting type fishing rods, with a preferred embodiment including a single-piece, lightweight, contoured pistol-grip type handle located on the rod ahead of the reel to afford the user exceptional fishing sensitivity due to direct finger contact with the fishing line extending from the reel. The handle also affords good control over rod twist and facilitates a more positive grip than conventional grasping of the rod during reeling. Also included is a rear forearm cradle that acts as a lever point which, when combined with the pistol-grip type handle, provides exceptional control of rod tip motions, useful during hook sets and while counteracting the pull of a fish. A preferred embodiment includes the pistol grip handle and forearm cradle features, either or both of which can be retrofitted to or incorporated into conventional casting rod handle designs that may include trigger grips and attachment mechanisms for securing a reel in place. Because of the two control points provided by the forward pistol-grip handle and rear forearm cradle, this embodiment facilitates use of only one arm to hold and support the fishing rod during reeling.

### CROSS-REFERENCE TO RELATED APPLICATIONS

This application claims the benefit of and incorporates by reference prior filed copending U.S. Provisional Application Ser. No. 60/628,154, Filed Nov. 16, 2004.

### FIELD OF THE INVENTION

The present invention relates to bait-casting type fishing rods and more specifically, provides a contoured pistol-grip type handle located on the rod ahead of the reel to afford the user exceptional fishing sensitivity due to direct finger contact with the fishing line. The handle also affords good control over rod twist and provides the fisherman more command of the rod than is possible when conventionally grasping the rod directly around the rod axis during reeling. In addition, a rear forearm cradle on or near the butt of the rod acts as a lever point and when combined in a preferred embodiment with the forward fulcrum point created by the handle, provides exceptional control of rod tip motions, useful during hook sets and while counteracting the pull of a fish. Accordingly, in this embodiment the invention requires the use of a single arm for support and power in playing fish of varying size.

Because conventional fishing rods must have a reel to retrieve the fishing line and lure, typical bait-casting rods require the fisherman to crank the reel with one hand while only one hand remains available to hold and stabilize the rod. As a consequence, without the application of some form of rigid support structure external to the fisherman's person, holding the rod using one hand while attempting to land even small fish can exert a significant strain on the fisherman's wrist. The present invention provides a comfortable, rigid grip for the fisherman to hold the fishing rod and at the same time, facilitates a natural hand orientation for touching the fishing line. As a result, added sensitivity is provided by being able to feel fluctuations in line tension.

Improved lure sensitivity is important, as any avid fisherman will attest. The present invention is unique because it affords the fisherman the facility to physically touch the line ahead of the reel and sense variations in line tension. These variations in line tension can be detected by the fisherman as a lure impacts the bottom, strikes submerged structures or is struck by a fish. The disparities between the feel of these very different lure-impact circumstances are easily interpreted by and very useful to the experienced fisherman.

The unique, ergonomic pistol-grip type forward handle of the present invention also provides the fisherman a solid grip located forwardly of the reel and is specially contoured to fit well in the palm of the fisherman's hand. With all five digits of the hand wrapped tightly around the ergonomic handle, the fisherman can easily counteract any rod-twisting forces experienced during fishing and fish retrieval. An added benefit of the forward handle location of the present invention is the close proximity to the fishing rod's center of gravity. Many artificial fishing lures require repetitive jerking motions or jigging of the rod to give the lures a lifelike appearance during retrieval. Since the forward handle fulcrum point is located close to the rod's center of gravity, less force is required to produce these jigging motions. This close proximity of the forward handle to the center of gravity of the rod also makes the rod easier to hold and handle due to the negation of cantilever effects of the unloaded rod on the fisherman's arm. This slight reduction in the effort required by the fisherman to control the rod is a feature most notable to persons prone to continuous fishing for long periods of time.

The design detailed in this application utilizes a slight offset of the forward handle from the rod longitudinal axis to ensure that the fisherman's forearm is held essentially parallel to the rod's longitudinal axis. Parallelism of the arm to the longitudinal rod axis is preferred in handling a fishing rod, since this factor allows for a more repeatable forearm attitude during transitions from casting to reeling. In addition, a parallel forearm location is the key to a more comfortable and natural feeling in handling the fishing rod. Another feature provided by the offset forward handle configuration of the present embodiment is that it is not limited to a specific reel design or reel attachment method. Regardless of the attachment method utilized in conjunction with the invention, the reel and attachment can function without alteration of conventional rod and reel designs.

In the repetitive casting of artificial lures, the fisherman typically handles the rod with his dominant hand for maximum power and control. Once the lure has reached its cast location, the fisherman typically switches the rod to his non-dominant hand so that the reel can be cranked using the dominant hand. Since the rod is typically repeatedly swapped from hand to hand while fishing, any form of stationary attachment to the non-dominant arm proves cumbersome and distracting. The design of this invention provides excellent rod leverage and control, while requiring the use of only one arm, particularly under circumstances where both the pistol-grip type forward handle and rear forearm cradle elements are in place on the fishing rod. This preferred design combination provides the user with a comfortable fulcrum point which repeatably locates the user's index finger and thumb in close proximity to the fishing line ahead of the reel to afford superior sensitivity to fluctuations in line tension. A lever point is also provided by the forearm cradle to reduce stress on the user's wrist and forearm.

### BRIEF SUMMARY OF THE INVENTION

The inventive preferred design provides increased rod leverage and excellent control of rod twist over conventional, straight-handled bait-casting fishing rods. The rear forearm cradle rests on or near the butt end of the rod and when combined with the ergonomic pistol-grip type handle located ahead of the reel, features a novel means of improved rod control while requiring the use of only one arm for rod support and use. Additionally, the design combination provides the user with a comfortable fulcrum point near the rod's center of gravity, which repeatably locates the user's index finger and thumb in close proximity to the fishing line ahead of the reel to afford superior sensitivity to fluctuations in line tension. The slight offset design of the forward grip ensures the rod's effectiveness, regardless of the style or design of bait-casting reel used in conjunction with the rod and provides a comfortable location of the fisherman's forearm substantially parallel to the rod. Furthermore, the design combination incorporates a conventional second grip behind the reel to be used during orthodox casting operations.

### BRIEF DESCRIPTION OF THE DRAWINGS

The invention will be more readily understood from a consideration of the following drawings, wherein:

FIG. 1 is a right side perspective view of a preferred embodiment of the invention, consisting of a forward-mounted, modified pistol-grip type handle and a rear-mounted forearm cradle, either or both retrofitted on a conventional bait casting rod;

FIG. 2 is a plan view of the handle assembly illustrated in FIG. 1;

FIG. 3 is a left-side perspective view of the forward mounted pistol-grip type handle illustrated in FIG. 1 and retrofitted on a conventional bait-casting rod, detailing typical contours associated with the forward handle;

FIG. 4 is a transverse sectional view of the forearm cradle illustrated in FIGS. 1 and 2, more particularly detailing a typical retrofitted attachment of the forearm cradle to a conventional fishing rod handle butt;

FIG. 5 is a left-side perspective view of the embodiment illustrated in FIG. 1, with the forearm cradle integrally shaped with the rod handle butt;

FIG. 6 is a bottom view of the embodiment illustrated in FIG. 1;

FIG. 7 is a plan view of the embodiment illustrated in FIG. 6;

FIG. 8 is a right side-view of a pistol-grip type handle which is molded or shaped integrally with the front grip and bait casting rod;

FIG. 9 is a plan view of the embodiment illustrated in FIG. 8, with the user's arm removed from the view for clarity and illustrating a forearm cradle;

FIG. 10 is a left side perspective view of the embodiment illustrated in FIG. 9; and

FIG. 11 is a left side view of a selected embodiment of the invention in use.

### DESCRIPTION OF THE PREFERRED EMBODIMENTS

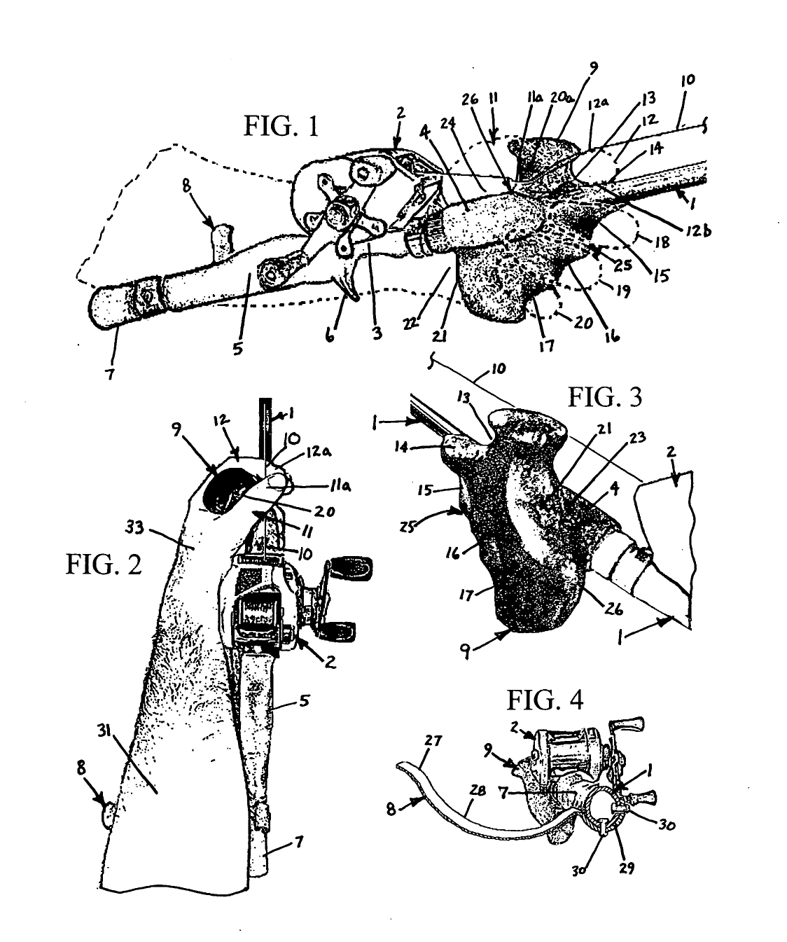

Referring now to the drawings, wherein like reference numerals designate identical or corresponding parts throughout the several views shown, FIG. 1 illustrates a conventional rod and reel assembly which has been modified to contain the fundamental components of a preferred embodiment of the present design. The conventional rod and reel assembly includes a conventional flexible member or rod 1, a bait-casting reel 2, mounted in a reel seat 3, a front grip 4, a rear casting handle 5 on the rod 1, an underside trigger support 6, and a rear handle extension or butt 7. Although many variations of the conventional rod and reel assembly exist, the design of this invention is applicable to all such assemblies, with minor, if any, alterations. The fundamental components of the present design are the rear forearm cradle 8 and the forward grip 9, which can be incorporated individually or collectively on the rod 1. The forearm cradle 8 is typically constructed of a resilient material such as plastic and typically protrudes nearly perpendicularly to the handle butt 7 on the conventional rod assembly. The forward grip 9 is located ahead of bait-casting reel 2 and is shaped and positioned thereon in such a way that when the forward grip 9 is grasped, the fishing line 10 is easily held between the user's thumb 11 and index finger 12 while fishing.

Referring now to FIGS. 1-7, the leading edge 25 of the forward grip 9 features a concave recess 13 near the top, to comfortably accept the index finger 12 of a user (FIGS. 1 and 2) and locate the tip 12a of the index finger 12 nearly perpendicular to the rod 1 and the fishing line 10. The elevation of the concave recess 13 is such that the index finger 12 comfortably crosses and protrudes between the rod 1 and the fishing line 10, extending from the reel 2. Directly below the concave recess 13, on the leading edge 25 of the forward grip 9, is a forward-protruding structure contour 14 which creates a horizontal ledge for receiving the bottom 12b of the index finger 12 (FIG. 1). Below the contour 14 on the leading edge 25 of the forward grip 9 are three, slightly concaved indentions 15, 16, and 17 which receive the fisherman's middle finger 18, ring finger 19, and pinky finger 20, respectively. The elevation of the indentions 15, 16 and 17 are such that the middle finger 18, ring finger 19 and pinky finger 20 are all positioned below the rod 1, thereby locating the rod 1 between the middle finger 18 and the index finger 12. The trailing edge 26 of the forward grip 9 contains another concaved recess 20a (FIG. 1), which is opposite the concaved recess 13 on the leading edge 25. The concave recess 20a receives the fisherman's thumb 11 and presents it at an angle of approximately 45 degrees with respect to the longitudinal axis of the rod 1 and the fishing line 10. The elevation of the concave recess 20a is such that the thumb tip 11a is naturally located near or slightly above the fishing line 10 (FIG. 2), thus allowing the fisherman to easily wrap his hand around the forward grip 9 and hold the rod 1 while still having the thumb tip 11a and index finger tip 12a available for feeling fluctuations in line tension by touching fishing line 10 (FIG. 2). Below the concave recess 20a on the trailing edge 26 of the forward grip 9 is a rearwardly-facing convex contour 21 (FIG. 3), which receives the palm 22 of the fisherman's hand (FIG. 1). Also below the convex contour 21 on the trailing edge 26, is provided a smooth, slightly concave contour 23, to receive the base portion of the fisherman's thumb 24.

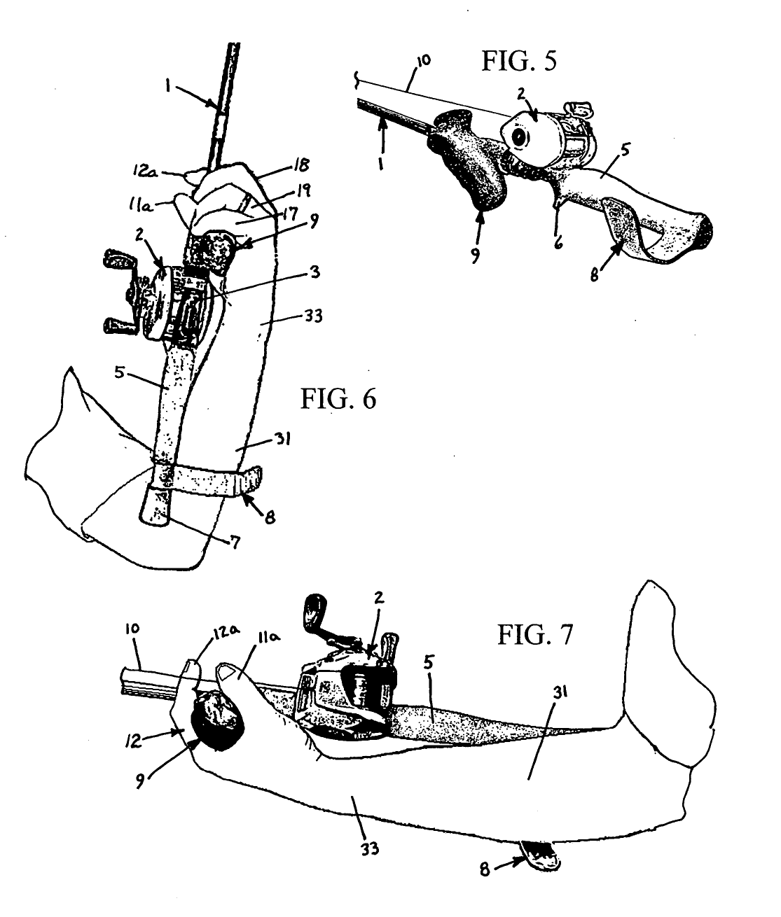

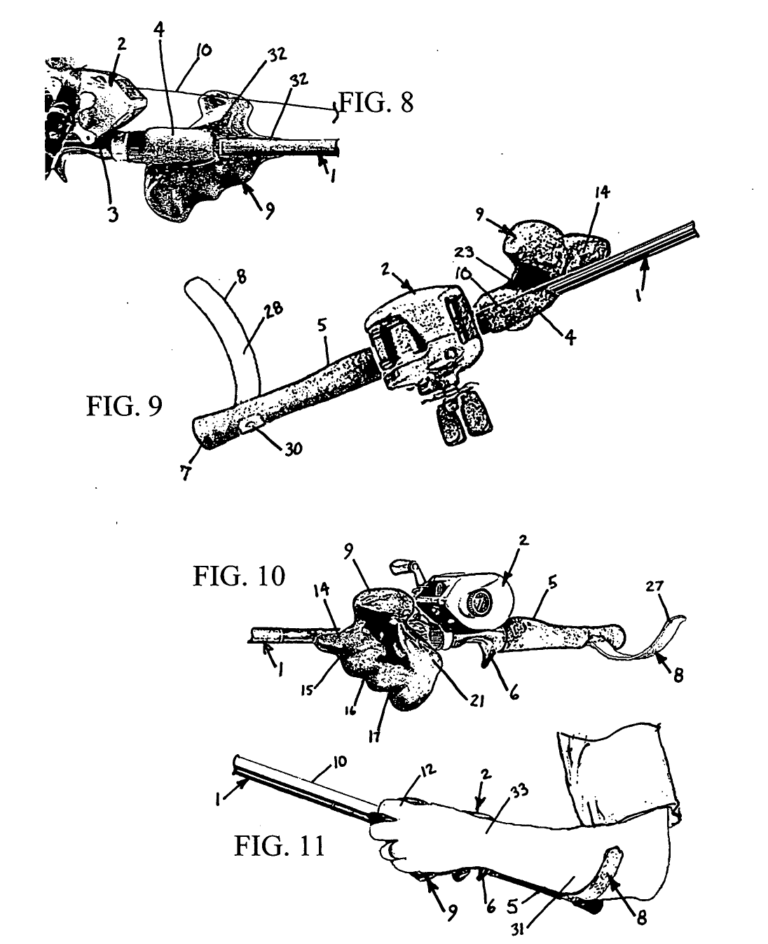

Referring now to FIG. 8 of the drawings, the forward grip 9 may be constructed of rigid, lightweight and impact-resistant materials such as fiberglass, plastic or light weight metal, in non-exclusive particular and in some cases, may be molded integrally with the front grip 4 and rod 1. Due to the complex shape of the part, the preferred material is one which is easily moldable to produce the final shape, whether as a retrofit part, as illustrated in FIGS. 8-10, or molded with the front grip 4 and rod 1, as illustrated in FIGS. 1-7. In one embodiment, the forward grip 9 typically contains a bore or concave cavity 32 (FIG. 8) to receive the conventional front grip 4 and/or rod 1 in a retrofit (FIGS. 8-10). The forward grip 9 is typically permanently secured to the conventional front grip 4 by epoxy, glue or other permanent attachment known to those skilled in the art in fishing rod construction. Depending upon the reel attachment style and the configuration of the reel seat 3, the forward grip 9 may also be permanently attached to or molded on the rod 1, as desired (FIGS. 1-7). Some reel attachment devices require that a conventional front grip 4 thread into place and hold the reel 2 secure in the reel seat 3. Consequently, gluing the forward grip 9 simultaneously to the rod and the conventional front grip 4 may be unacceptable in such a design, because the reel 2 would then be trapped in place and impossible to conveniently remove. Therefore, in a preferred embodiment of the invention the standard screw-type device in the front grip 4 for securely attaching the reel 2 to the reel seat 3 is separate and clear of the front grip 4, which is permanently affixed to the rod 1. To facilitate ease in manufacturing, the forward grip 9 and the forearm cradle 8 are each typically securely attached to rod 1 by way of epoxy, glue or other standard industry practice known to those skilled in the art, although the forearm cradle 8 may, like the front grip 4, be shaped or molded integrally with the handle butt 7 of the rod 1 (FIG. 5).

Another embodiment of the invention combines the fundamental shapes of the forward grip 9 and the conventional front grip 4 of the retrofitted embodiment with a threaded device for tightening the reel 2 into the reel seat 3, all in a single moldable shape. A second moldable shape combines the forearm cradle 8 with other conventional rod handle elements, including, but not limited to, a rear casting handle 5 having a handle butt 7 and an underside trigger support 6, into a single part which is attached to rod 1 using standard industry practices such as gluing. Accordingly, these two moldable shapes may be secured in place on the rod 1 separately, or in combination to produce an easily manufactured, readily assembled, aesthetically pleasing and fully functional embodiment of the present invention.

Referring again to FIGS. 7, 8, 9 and 10 of the drawings, since the forward grip 9 is located ahead of the reel 2, it is oriented in such a way that the normal path of the fishing line 10 from the reel 2 is not obstructed. Avoiding interference with the fishing line 10 is accomplished by a transverse offset of the forward grip 9 from the longitudinal axis of the rod 1 and a slight rotation around this axis, until substantial line clearance is achieved. Adding to the functionality of the forward grip 9, is its location longitudinally along the longitudinal axis of the rod 1, such that it is oriented sufficiently forward to allow room for the fisherman's thumb to comfortably fit between the forward grip 9 and the reel 2.

Referring now to FIGS. 2, 4, 6, 7, 9 and 11, in the combination embodiment of the forward grip 9 and the forearm cradle 8, the shape of the forward grip 9 is offset from the longitudinal axis of the rod 1 such that the fisherman's forearm is approximately parallel to the rod 1 when holding forward grip 9 and placing a forearm in the recess 28 of the forearm cradle 8. By locating the forearm 31 and the wrist 33 alongside the reel 2, changes in reel shape or mounting do not affect the primary location of the forward grip 9 and the forearm cradle 8, making this embodiment of the invention both scaleable and versatile.

Referring again to FIG. 4 of the drawings, the forearm cradle 8 is rigid and is typically connected to the conventional rod handle butt 7 by application of rivets 30 and/or epoxy or glue (not illustrated). The forearm cradle 8 is typically constructed of a selected rigid and fracture-resistant material such as aluminum, fiberglass and plastic, in non-exclusive particular and the outwardly-extending portion 27 is preferably convexly contoured to easily guide the fisherman's forearm 31 onto the shaped cradle recess 28. Typically, the rod 1 of a conventional fishing rod extends through the length of the handle butt 7. The radius 29 of the forearm cradle 8 matches the radius of the handle butt 7 and padding on the rod 1 is typically removed prior to attachment of the forearm cradle 8, to ensure that a rigid attachment is achieved. Although epoxy, glue and rivets are included in the drawings as typical expedients to permanently secure the forearm cradle 8 to the conventional fishing rod handle butt 7, other means of attachment and techniques familiar to those skilled in the art may be utilized to accomplish this purpose.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A bait-casting handle for a fishing rod having a reel provided with fishing line, comprising an ergonomically-shaped handle provided on the fishing rod forwardly of the reel for supporting and controlling the fishing rod by a user.

2. The bait-casting handle of claim 1 comprising a plurality of indentations provided in said handle for receiving the fingers and thumb of the user.

3. The bait-casting handle of claim 2 wherein at least two of said indentations are positioned on said handle for receiving the index finger and thumb of the user, wherein the index finger extends between the fishing rod and the fishing line for grasping the fishing line between the thumb and the index finger of the user.

4. The bait-casting handle of claim 3 wherein said handle is permanently carried by the fishing rod.

5. The bait-casting handle of claim 3 wherein said handle is removably secured to the fishing rod.

6. The bait-casting handle of claim 1 comprising a forearm cradle provided on the fishing rod rearwardly of the reel for receiving and supporting the forearm of the user.

7. The bait-casting handle of claim 6 comprising a plurality of indentations provided in said handle for receiving the fingers and thumb of the user.

8. The bait-casting handle of claim 7 wherein at least two of said indentations are located on said forward handle for receiving the index finger and thumb of the user, wherein the index finger extends between the fishing rod and the fishing line for grasping the fishing line between the thumb and the index finger of the user.

9. The bait-casting handle of claim 8 wherein said forearm cradle is permanently carried by the fishing rod.

10. The bait-casting handle of claim 8 wherein said forearm cradle is removably secured to the fishing rod.

11. A bait-casting handle for a fishing rod having a reel provided with fishing line, comprising a handle provided on the fishing rod forwardly of the reel and at least one indentation provided in said handle for receiving the hand of a user and controlling the fishing rod.

12. The bait-casting handle of claim 11 wherein said at least one indentation comprises a plurality of indentations for receiving selected fingers and the thumb of the user.

13. The bait-casting handle of claim 12 wherein at least two of said indentations are positioned on said handle for receiving the index finger and thumb of the user, wherein the index finger extends between the fishing rod and the fishing line for grasping the fishing line between the thumb and the index finger of the user.

14. The bait-casting handle of claim 13 wherein said handle is permanently carried by the fishing rod.

15. The bait-casting handle of claim 13 wherein said handle is removably secured to the fishing rod.

16. The bait-casting handle of claim 11 comprising a forearm cradle provided on the fishing rod rearwardly of the reel for receiving and supporting the forearm of the user.

17. The bait-casting handle of claim 16 wherein said at least one indentation comprises a plurality of indentations for receiving selected fingers and the thumb of the user.

18. The bait-casting handle of claim 17 wherein at least two of said indentations are positioned on said handle for receiving the index finger and thumb of the user, wherein the index finger extends between the fishing rod and the fishing line for grasping the fishing line between the thumb and the index finger of the user.

19. A bait-casting handle for a fishing rod having a reel provided with fishing line, comprising an ergonomically-shaped handle provided on the fishing rod forwardly of the reel for supporting and controlling the fishing rod by a user and a forearm cradle provided on the fishing rod rearwardly of the reel for receiving and supporting the forearm of the user.

20. The bait-casting handle of claim 19 comprising at least two indentations provided on said handle for receiving the index finger and thumb of the user, wherein the index finger extends between the fishing rod and the fishing line for grasping the fishing line between the thumb and the index finger of the user.
